(19) United States
(12) Patent Application Publication
(10) Pub. No.: US 2002/0120465 A1
(43) Pub. Date: Aug. 29, 2002

(54) Utilizing and delivering contents

(75) Inventors: Masaya Mori, Kasawaki-shi (JP); Yoriko Okamoto, Yokohama (JP)

Correspondence Address: IBM CORPORATION, INTELLECTUAL PROPERTY LAW DEPT., P.O. Box 218, YORKTOWN HEIGHTS, NY, 10598, US

(73) Assignee: International Business Machines Corporation, Armonk, NY (US)

(21) Appl. No.: 10/078,053

(22) Filed: Feb. 15, 2002

(30) Foreign Application Priority Data
Feb. 27, 2001 (JP) 2001-53193

(51) Int. Cl. G06F 17/60

(52) U.S. Cl. 705/1

(57) ABSTRACT

The present invention provides for deterring and/or preventing an illegal use of contents by users when an expiration date is established for the use of the contents. Contents or contents execution programs have information indicative of an expiration date. In an example, expiration date information is embedded into external files, contents or contents execution programs. The expiration date information could be a start, end or last date of use, which is used as authentication data to conduct authentication when making use of the contents. An example embodiment has two requirements satisfied when using the contents in order to execute the execution program, including (1) the current date acquired from the system timer is between the start date of use and the end date of use (expiration date); and (2) the current date is posterior to the last date of use (last date of access).

### FIELD OF THE INVENTION

The present invention relates to a method, system and program for delivering contents, and more particularly to a technique effectively applied when establishing an expiration date for the use of the contents.

### BACKGROUND

Along with the progress of network technologies such as the Internet, network delivery of digital contents has been conducted on a commercial basis, including images, videos, audio, application software, etc. As in the case where the contents are recorded in media such as a CD-ROM and sold, the network delivery of these digital contents needs no production, inventory, distribution, and over-the-counter sale, so that it is expected to be a promising means to expand the sales of digital contents (or information). Namely, the network delivery can deliver contents to users only by exchanging information, wherein a direct sale of the contents would be completed almost automatically by using an appropriate means of settlement together. For sellers, they can cut down on managerial resources such as personnel, equipment, assets, etc., while users can acquire contents quickly at any time wherever they are. Therefore, the network delivery of contents is convenient both for sellers and users, leading to a reduction of selling costs, thereby reducing the selling prices at last.

However, since digital contents are digital information, they are essentially reproducible, wherein deterioration in quality due to the reproduction is extremely small. In addition, the reproduced contents may be distributed almost at once on a global scale using the network, whereby the rights of contents owners such as a copyright may be significantly infringed on. This is why the technique to prevent reproduction is important, as a result in general, various kinds of authentication means are provided in execution programs of contents, whereby only a person who is authenticated can activate the execution program to use the contents.

On the other hand, sometimes an expiration date is established in association with the use of contents. For example, such a case would be when distributing a special purpose application software for trial use or shareware that is distributed at a low price. Furthermore, when delivering music software or video software such as a movie for the purpose of accounting, an expiration date may be established. In this way, it is possible to enlarge opportunities to use contents by selling them with the expiration date established or to facilitate the use of contents by making the charge for use of them cheaper.

A common technique to establish an expiration date for the contents is to apply the expiration date to the contents or the contents execution programs and to make a decision whether the expiration date has been expired using a system timer of an information processing system, such as a computer that executes the program. As an example, Japanese Unexamined Patent Publication No. 1999-31130 describes a technique for applying an expiration date to delivery data from the Internet.

However, the aforementioned prior art alone may simply allow the unauthorized use by users. That is, it is possible to prevent the illegal reproduction of the contents or their execution programs by using the aforementioned reproduction preventing means. However, only relying on the reproduction preventing means, the illegal use can not be prevented effectively when the expiration date is established for the use of the contents. Namely, according to the prior art, the expiration date of the contents is determined by using a system timer of a computer on which the contents execution program runs, thus the use or regeneration of the contents may become possible even if the expiration date has actually expired, if a user intentionally changes the system timer to set back the date and time within the expiration date. As a result, there is no meaning to establish the expiration date for the use of the contents.

### SUMMARY OF THE INVENTION

Therefore, it is an aspect of the present invention to provide a technique for deterring or preventing an illegal use of contents by users when an expiration date is established for the use of the contents.

According to the present invention, contents or contents execution programs have information indicative of an expiration date. The expiration date information is embedded into external files, contents, or contents execution programs, for example.

An example embodiment for authentication has two requirements satisfied when using the contents in order to execute the execution program, including (1) the current date acquired from the system timer is between the start date of use and the end date of use (or the current date is prior to the end date of use); and (2) the current date is posterior to the last date of use.

Another aspect of, the present invention is to provide a counter for counting independent time during an operation of the system and/or the OS independent of the system timer, wherein if the difference is found between the time acquired from this counter and the system timer when executing the contents, the end date of use (i.e., expiration date) could be corrected using the time period corresponding to the difference. This enables the prevention of the continuation of an illegal use due to a change of the time that is targeted at the period between the last date of use and the end date of use (expiration date).

### BRIEF DESCRIPTION OF THE DRAWINGS

These and other objects, features, and advantages of the present invention will become apparent upon further consideration of the following detailed description of the invention when read in conjunction with the drawing figures, in which:

FIG. 1 is a conceptual diagram of an example system that implements a method for delivering contents according to an embodiment of the present invention;

FIG. 2 is a block diagram depicting a terminal system (client) and a server system;

FIG. 3 is a flowchart depicting an example method for delivering contents according to an embodiment of the present invention;

FIG. 4 is a flowchart illustrating an example of regeneration processing of the contents on the part of client; and

FIG. 5 is a diagram illustrating a flow of said processing in time series.

### DESCRIPTION OF THE SYMBOLS

1: Internet

2: Computer system

3: Cellular phone

4: Personal digital assistants (PDA)

5: Server

6: Browser

7: Contents

8: Authentication file

9: Execution program

10: Communication means

11: Time information generating means

12: Authentication file generating means

13: Download program file generating means

14: Compressed file generating means

15: Contents

16: Communication means

t1-t7: Time

### DESCRIPTION OF THE INVENTION

The present invention provides methods, apparatus and systems for deterring or preventing illegal use of contents by users when an expiration date is established for the use of the contents. According to the present invention, contents or contents execution programs have information indicative of an expiration date. The expiration date information is embedded into external files, contents, or contents execution programs, for example. The expiration date information could be a start date of use, an end date of use (expiration date), and a last date of use, which are used as authentication data to conduct authentication when making use of the contents (e.g., when executing the contents execution program). A technique for authentication would be, for example, that two requirements should be satisfied when using the contents in order to execute the execution program, including (1) the current date acquired from the system timer is between the start date of use and the end date of use (or the current date is prior to the end date of use); and (2) the current date is after the last date of use.

Using such a method for executing the contents, use of the contents within the expiration date is allowed. Even if the user wrongly sets back the system timer, the use of the contents is restricted in order to prevent the illegal use of the contents with the expiration date applied when the above requirement (2) is not satisfied.

Furthermore, the present invention provides for a counter for counting independent time during an operation of the system or the OS independent of the system timer, wherein if the difference is found between the time acquired from this counter and the system timer when executing the contents, the end date of use (i.e., expiration date) could be corrected using the time period corresponding to the difference. This allows prevention of the continuation of illegal use due to a change of the time that is targeted at the period between the last date of use and the end date of use (expiration date).

Now an example embodiment of the present invention will be described with reference to the accompanying drawings. However, it should be noted that the present invention could be implemented in many different manners, thus should not be comprehended to be limited to the embodiments described herein. Throughout the drawings, the same elements are shown with the same reference numbers.

In the following embodiment of the present invention, a method and system will be mainly described, however, it would be obvious to those ordinary skilled in the art that the present invention could also be implemented as a program available in a computer. Therefore, the present invention is implemented in hardware, software and a combination thereof. The program could be recorded on any computer-readable medium such as a hard disk, CD-ROM, optical storage or magnetic storage.

Furthermore, in the following embodiment, a typical computer system may be used. A computer system used in the embodiment comprises hardware resources quipped in a typical computer system, including a central processing unit (CPU), main storage (main memory, i.e., RAM), nonvolatile storage (ROM), coprocessor, image accelerator, cache memory, input/output controller (I/O), etc. In additions, an external storage such as a hard disk drive and communication means to connect to a network such as the Internet may be provided as well. Such a computer system includes various kinds of computers such as a personal computer, workstation, mainframe computer, etc.

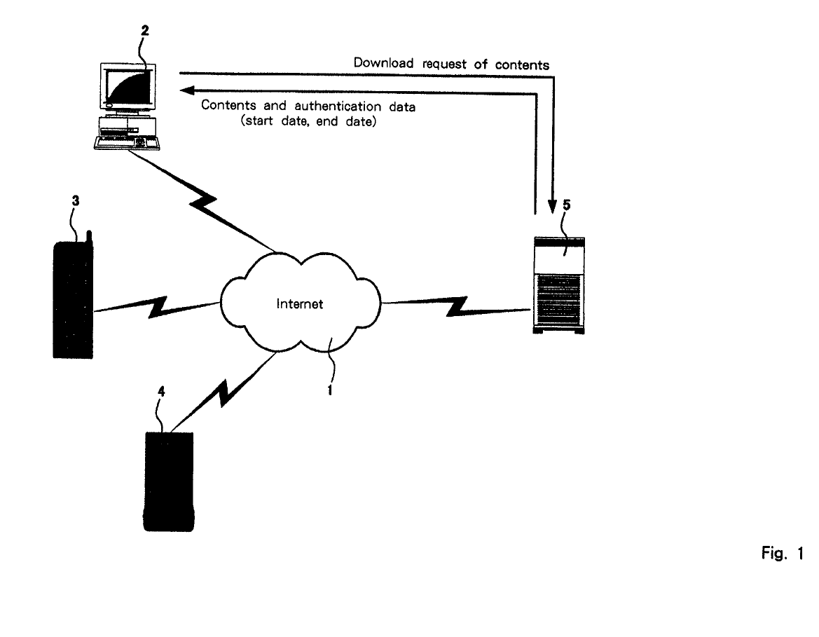

FIG. 1 is a conceptual diagram of an example system that implements a method for delivering contents according to an embodiment of the present invention. The contents delivery system according to the present invention comprises terminals for requiring delivery of contents, including a computer system 2, cellular phone 3, PDA (personal digital assistants) 4, and a server 5 for delivering contents, those of which are connected to the Internet 1. The terminal serving as a destination of the contents (hereinafter simply called terminal), such as computer system 2, cellular phone 3, PDA 4, issues a request to server 5 for delivery of contents, then the server 5 delivers the contents and authentication data to the terminal. Receiving the contents and authentication date, the terminal regenerates or executes the contents for users by using a means as described later in detail.

It is noted that as used herein, the term regenerate refers to and includes regeneration only, execution only, and both regeneration and execution, each or both being employed as desired for the application at hand. Thus a regeneration program for said contents, includes only a regeneration program, only an execution program for said contents, and both a regeneration and an execution program for said contents, depending upon the particular utilization of the concepts of the present invention. The term authentication data refers to the actual data or an encoded file thereof.

The Internet 1 is one type of network that is opened worldwide, wherein the communication is made according to the IP (Internet protocol), as is well known in the art. The Internet is exemplified herein, however, other types of networks may be also used. For example, a network connected by a dedicated telephone line or a cable network such as a CATV may be used. The concept of the Internet contains an intranet wherein the use is generally restricted. In addition, here will be described an example where the terminals are connected to the server 5 by way of the communication means such as the Internet, however, the request and delivery may not be necessarily performed by way of the network. For example, in response to a request from a user by way of mail or telephone, a business proprietor managing the server 5 may deliver the contents and authentication data by way of media such as a CD-ROM. However, when not using the network, since download programs described below can not be used, thus compressed files and authentication data 2 are to be delivered.

The computer system 2 is a typical computer system as described above and has a typical communication means for connecting to the Internet 1. The cellular telephone 3 has data communication functions, such as i-mode, corresponding to the Internet as well as telephone functions. The PDA 4 fundamentally has the functions similar to the computer system 2 except that part of the functions are restricted, thus providing for a communication function to connect to the Internet. Preferably installed on the computer system 2, cellular phone 3 and PDA 4 is appropriate browser software that issues an HTTP (Hypertext Transfer Protocol) request. The server 5 may be a typical computer system having an appropriate communication means.

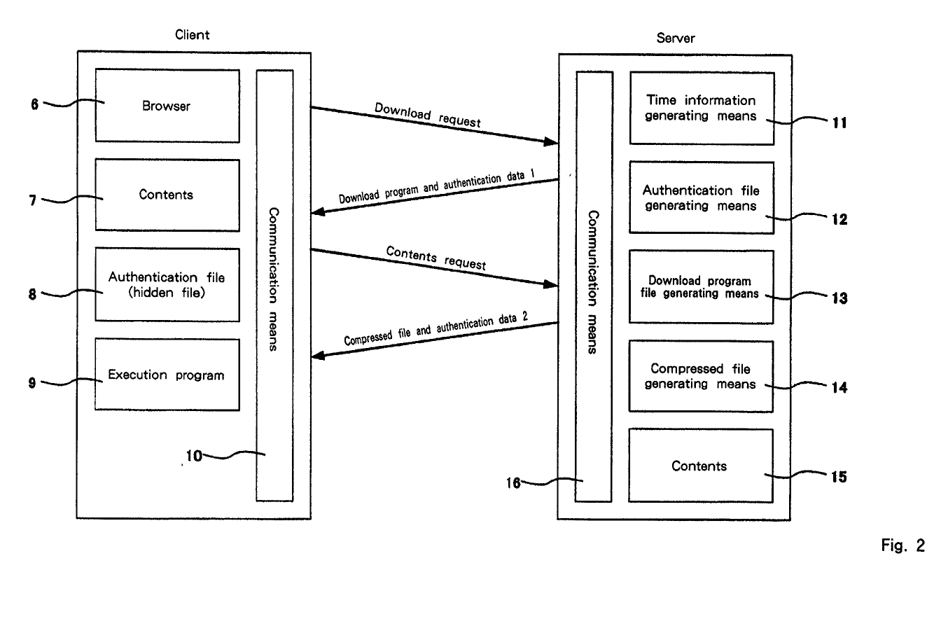

FIG. 2 is a block diagram depicting a terminal system (client) and a server system 5. The client system comprises a browser 6, contents 7, authentication file 8, execution program 9, communication means 10, for example. The server system comprises time information generating means 11, authentication file generating means 12, download program file generating means 13, compressed file generating means 14, contents 15, communication means 16, for example. It should be noted that the client system in FIG. 2 shows the condition after the download program file has been executed. The browser 6 in the client system is used to connect to the Internet 1 and to issue an HTTP request to the server 5. A typical browser may exemplify the browser 6. The contents 7 are contents data that has been downloaded from the server 5 and is ready for use. The contents 7 include software resources subject to use for users, such as voice files, image files, application programs, etc.

The authentication file 8 contains authentication 1 data that is referred to when downloading the contents, authentication 2 data that is referred to when decompressing the contents, and authentication 3 data that is referred to when regenerating and executing the contents, as described below in detail. These authentication data are preferably retained as a hidden file. This prevents or deters the user from tampering. In addition to making them the hidden file, it is effective to rewrite the edit date of this authentication file (date and time of file generation and change) into the date of installation of the OS. This makes it difficult for users to search for the hidden file, thereby more effectively preventing it from being tampered.

The execution program 9 is a program that regenerates and/or executes the contents 7. For example, it may be an MP3 regeneration program, an MPEG regeneration program, or a program for activating an application program. Communication means 10 communicates with communication means 16 of server 5 over the Internet 1. Time information generating means 11 of server 5 generates a date of that moment and a date after the valid term (i.e., expiration date) in response to a download request from a client, and further primarily generates data corresponding to a start date of use and an end date of use that are to be contained in the authentication 3 data.

Authentication file generating means 12 generates authentication 3 data from the time information generated by the time information generating means 11 and further generates the authentication 1 data and authentication 2 data automatically. The authentication 1 data indicates where the compressed contents file (including the authentication 2 data) is stored, which is used by the download program. The authentication 2 data is used to decompress the compressed file. The authentication 3 data is used when making use of the decompressed contents (i.e., regeneration and/or execution). Download program file generating means 13 generates a program file for downloading the compressed file, as described below. Embedded in the download program file is the authentication 1 data.

Compressed file generating means 14 generates the encoded execution programs, the authentication 3 data, and the contents. Embedded in the compressed file is the authentication 2 data. Encoding of the execution programs and contents might be scrambled such that they are decoded using the authentication 2 data. Scrambling uses, for example, the data hidden scheme or bit shift scheme. The compressed file is preferably decompressed in a self-extracting manner when it is executed on the part of client. The compressed file is stored at the address specified by the authentication 1 data. The contents 15 are software resources used by users. According to this embodiment of the invention, the contents 15 as such are not to be downloaded to users.

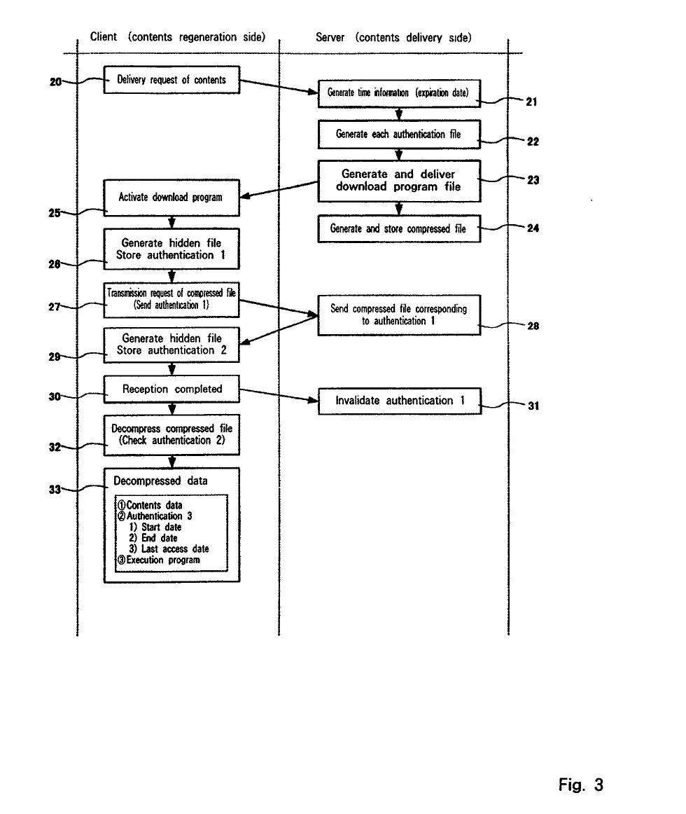

FIG. 3 is a flowchart depicting an example method for delivering contents according to an embodiment of the present invention. First, the client issues a request to the server 5 for delivery of contents (step 20). The request may be an HTTP request, for example. In receipt of this request, the server 5 generates time information (step 21). The time information is generated by the time information generating means 11 using the system timer of the server 5. There are generated the date when the request is received (i.e., start date for use) and the date that results from adding the valid term to the start date of use (i.e., end date of use, that is, expiration date).

Then, the server 5 generates the authentication files using the authentication file generating means 12 (step 22). The authentication files include authentication 1 to 3 data, as described above. The authentication 1 data specifies any address in the server, while the authentication 2 data is generated randomly. Concerning the authentication 3 data, the times generated by the time information generating means 11 are applied to the start date of use and the end date of use. On the other hand, concerning the authentication 3 data, the last date of use (i.e., last access date) might be any value since the contents have not been utilized, however, it is assumed here that the last date is the start date of use.

Next, the server 5 generates the download program file, which embeds the authentication 1 data, by using the download program file generating means 13 and sends it to the client (step 23). Moreover, the server 5 generates the compressed file using compressed file generating means 14, in preparation for a request for the compressed file from the client. The compressed file generated is stored at the address specified by the authentication 1 data (step 24). On the other hand, in receipt of the download program file, the client activates the download program (step 25). The activation of the download program may be automatically activated upon completion of the receipt.

Then, the client stores the authentication 1 data embedded in the download program file in the authentication file 8 (step 26), then issues a download request of the compressed file according to the processing of the download program (step 27). At this time, the download request requires that a file be downloaded which is stored at an address referenced with the authentication 1 data, thus the compressed file could not be downloaded if no file exists at the address referenced with the authentication 1 data. Namely, even if the user copies the download program and gives it to a third party, the third party can not download the compressed file because he does not have the hidden file in which the authentication 1 data is stored. In this way, the download program file that is illegally copied could be invalidated, thereby deterring or preventing illegal copies by the third parties.

Upon receipt of the request for transmission of the compressed file, the server 5 sends the file that is referenced with the authentication 1 data (step 28). This file should be the intended compressed file if it is the one as processed in step 24.

Upon receipt of the compressed file, the client separates the authentication 2 data from the compressed file and stores the authentication 2 data in the hidden file (step 29). Upon completion of receipt of the compressed file (step 30), the server 5 invalidates the authentication 1 data (step 31). This prevents or deters repetitive or illegal downloading.

Upon completion of downloading of the compressed file, the client performs decompression processing (step 32). Decompression may be performed automatically in a self-extracting manner. According to the present invention, upon decompression, the compressed file is decoded by referring to the authentication 2 data. In this way, making decompression impossible without referring to the authentication 2 data, an illegal copy of the compressed file could be prevented.

After decompression of the compressed file, the contents, authentication 3 data and execution program are retained in an available condition in the client system (step 33). The execution program may not be activated without referring to the authentication 2 data. This prevents illegal use of the contents after decompression.

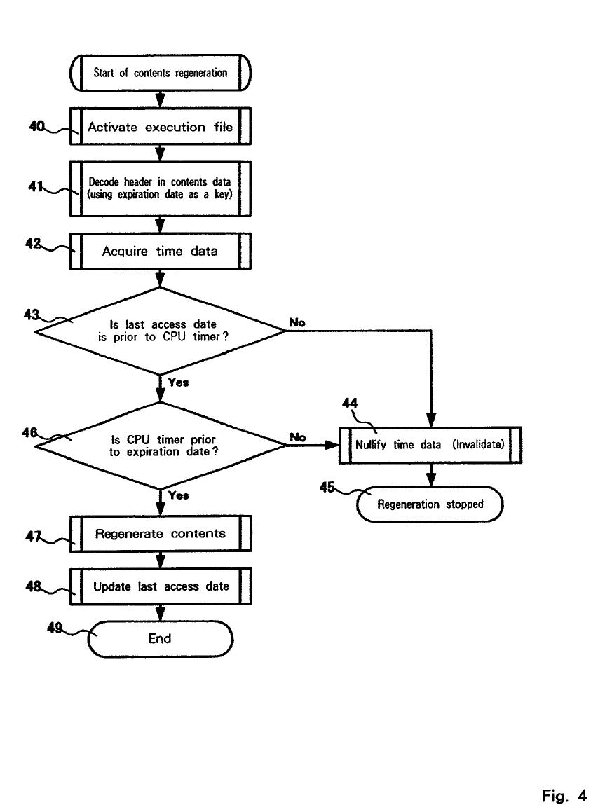

FIG. 4 is an example of a flowchart illustrating regeneration processing of the contents on the part of client. First, a terminal of the client activates the execution file (step 40). As described above, the authentication 2 data may be referred to upon this activation. Then, the header of the contents is decoded using the expiration date (step 41). It is assumed that encoding corresponding this decoding has been performed on the contents data in advance. If the contents data has been encoded using the expiration date like this, the contents may be prevented from being copied illegally. Then, the time data stored in the hidden file as the authentication 3 data is acquired (step 42). Using this time data acquired, it is determined whether the last date of access (last date of use) is prior to the time of the system timer (CPU timer) (step 43). If it is not, corresponding to a false, this indicates a contradiction that can not occur in a normal use, that is, the CPU timer is prior to the last date of access. In this case, on the basis of determination that the CPU timer was set back wrongly, the time data (authentication 3 data) is nullified (step 44) and the regeneration is stopped (step 45). Nullifying the authentication 3 data (time data), the contents data will be impossible to be decoded thereafter, thereby disabling the use of the contents.

On the other hand, if the determination of step 43 is Yes, corresponding to true, it is determined whether the time of the CPU timer is prior to the expiration date (i.e., within the expiration date) (step 46). If No, the authentication 3 data is nullified and then the regeneration is stopped as in the case of negation of the determination step 43. This restricts the use of the contents that have exceeded the expiration date. If determination step 46 is Yes, corresponding to true, the contents are regenerated (step 47). If determination steps 43 and 46 are affirmed, it is determined to be a legal use within the expiration date.

After regeneration of the contents, the last date of access (last date of use) for the authentication 3 data is updated (step 48). The last date of use updated will be referred to at the next time when the contents are used. Thereafter, the regeneration processing is terminated (step 49). Alternatively, the date of downloading may be recorded as the last date of use when the contents have been downloaded.

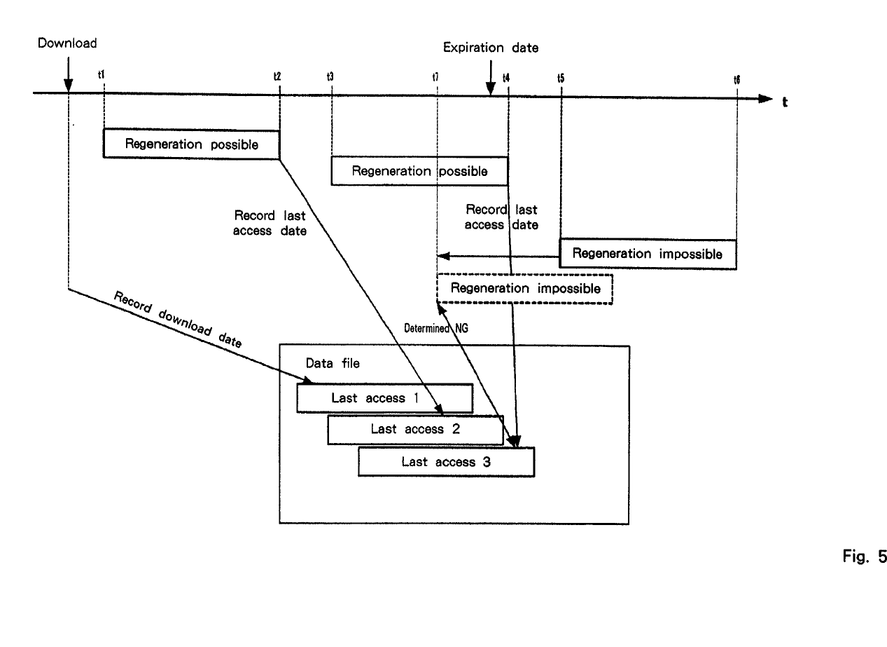

FIG. 5 is a diagram illustrating a flow of said processing in time series. When downloading is performed, the date of downloading is recorded in the data file (authentication 3 data) as the last date of use. This is made to be the last access 1. Then, if the processing shown in FIG. 4 is performed when regeneration is started at time t1, regeneration is performed normally because the date of regeneration (current time) is posterior to the last date of access and within the expiration date. Then, when regeneration is finished at time t2, its time is recorded as the last date of use for the last access 2. Then if regeneration is attempted at time t3, the regeneration is enabled just like at time t1. It is noted that if the expiration date expires in the course of regeneration, regeneration should be performed to the end.

When regeneration is attempted at time t5 after the expiration date, the current date is posterior to the expiration date (end date of use), thus regeneration is disabled. Assuming that at this moment the user sets back the system timer (CPU timer) to time t7 attempting an illegal use. In this case, determination step 46 in FIG. 4 is affirmed, while determination step 43 [determined to corresponds to false] is denied,. That is, since time t4 is recorded in the last access 3 as the last date of use in the previous regeneration, contradiction occurs that essentially should not occur, that is, time t7 is prior to time t4. According to the present invention, such an illegal use is detected, deterred and/or prevented.

However, assuming that the user does not perform the second regeneration operation (i.e., t3 through t4) and instead performs an illegal operation of the timer (to set back the current time), such that the third regeneration operation (t5 through t6), which is essentially impossible to be regenerated, is to be between time t2 and the expiration date, regeneration could be performed and further the last date of use is illegally brought forward. If such an illegal operation is repeated, it is feared that a substantial expiration date might be prolonged. Against such a case, the following countermeasures are generally taken.

Namely, there is provided a counter means distinct from the system timer in an independent program such as a DLL (dynamic link library) that cooperates with the execution program 9. Since such an independent program does not stop while the system is running or a specific OS is running, it can be configured so as to consume the expiration date as long as the computer (or OS) is running. Namely, a counter by means of an independent program is to always update the current time with the system timer when the system (or OS) is started up. Therefore, a determination is made as to whether illegal setting back of the system timer was performed when activating the execution program 9 (i.e., if an illegal operation of the timer was performed, the time of the independent program should proceed ahead of the system timer), then a time period corresponding to an illegal operation is recorded by referring to the system timer. Upon execution of the execution program 9, the last date of access and the expiration date (alternatively, an acquired value of the CPU timer (or system timer)) are corrected using said time period. After that, the aforementioned processing is to be performed using the time data corrected. It is noted that the correction should be made such that when correcting the last date of access and the expiration date, said time period is subtracted from their original dates, while when correcting the acquired value of the CPU timer, said time period is added to the acquired value. According to this, a legal expiration date is able to be determined. Consequently, when correcting the last date of access and the expiration date, the last date of access and expiration date that have been corrected are recorded, while when correcting an acquired value of the CPU timer, said time period is recorded in order to be referred to when processing the execution program later. The independent program should be installed when executing the execution program 9 for the first time, and thereafter should function all the time while the system is operating.

As mentioned above, the present invention has been described with regard to the preferred embodiments, however, the present invention would not be limited to those embodiments and various modifications and changes may occur to those skilled in the art without departing from the spirit and scope of the invention.

For example, in the above embodiments, each of the authentication data 1, 2 and the time data (start date of use) of the authentication data 3 are used to prevent copying of each file or program. However, the technique for preventing copying is not limited to the aforementioned method, but other various techniques may be used. For example, the electronic watermark may be used.

Also, in the above embodiments, another file (i.e., a hidden file) is used to record authentication data, however, this may not be the only case. For example, the expiration date may be embedded in the contents themselves or the execution program itself.

In the above embodiments, an operation for setting back the system timer in the course of regeneration may be prohibited. Further, in the above embodiments, the computer system 2, cellular telephone 3, and PDA 4 are exemplified as a client system, however, they may not be the only case. For example, a video playback unit connected to the Internet 1 may be used. In this case, time information and other authentication data would be embedded in a header area of video data, wherein various kinds of authentication processing described above could be performed using this authentication data.

Furthermore, in the example embodiments described above, the server 5 sends the contents and necessary authentication data at the same time in response to a delivery request of the contents, however, they may be delivered at different times. For example, in response to a request from a client, authentication data (i.e., expiration date information and data necessary to regenerate and execute the contents) might be sent first, then the contents might be delivered each time when a client desires regeneration and execution of the contents, that is to say, on demand delivery. In this case, the contents delivered on demand become available after regenerated and executed as described above in the embodiments by using the authentication data previously acquired. Concerning the authentication data previously acquired, authentication may be granted comprehensively with respect to the contents within a predetermined range. Namely, authentication data and contents need not have the one-to-one correspondence, whereby one authentication may be granted to a plurality of contents or the contents that are to be provided in the future.

Thus, according to the present invention, there is provided a technique for preventing an illegal use of contents by users when an expiration date is established for the use of the contents.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or after reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention.

Further the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A method for utilizing contents, comprising the steps of:
acquiring authentication data including a start date of use for the contents, an end date of use for the contents, and a last date of use;
acquiring a current date from a system timer when using the contents;
determining whether said last date of use is prior to said current date;
determining whether said current date is prior to said end date of use;
regenerating said contents if both of said steps of determining result in true; and
updating said last date of use with a date when said regenerating step is finished.

2. The method according to claim 1, wherein at least a part of said contents are encoded using encryption data contained in said authentication data, the method further comprising the step of decoding the encoded contents using said encryption data.

3. The method according to claim 2, further comprising the step of nullifying said encryption data if a step of determining results in false.

4. The method according to claim 1, wherein said authentication data is recorded using at least one scheme taken from a group of schemes including:
a scheme of storing said authentication data in a file generated as a hidden file;
a scheme of embedding said authentication data in said contents; and
a scheme of embedding said authentication data in a program that regenerates said contents.

5. A method for delivering contents; comprising the steps of:
in response to a download request of the contents, generating authentication data using a date when said request is accepted, wherein said authentication data includes a start date of use specifying the start date of use for the contents and an end date of use specifying an expiration date of the contents; and
sending the contents, a regeneration program for said contents, and said authentication data, wherein the regeneration program comprising the functions of:
acquiring a current date from a system timer;
determining first whether the last date of use of said contents is prior to said current date;
determining secondly whether said current date is prior to said end date of use;
regenerating said contents if determinations made by both of said determination functions result in true; and
updating said last date of use with a date when the regeneration of said contents is finished.

6. The method according to claim 5, further comprising encoding at least a part of said contents using encryption data contained in said authentication data and forming encoded contents, wherein said regeneration program further includes the function of decoding said encoded contents using said encryption data.

7. The method according to claim 6, wherein said regeneration program further comprising the function of nullifying said encryption data if a step of determining results in false.

8. The method according to claim 5, wherein said authentication data is recorded using at least one schemes taken from a group of schemes including:
a scheme of storing said authentication data in a file generated as a hidden file of a system in which said regeneration program is executed;
a scheme of embedding said authentication data in said contents; and
a scheme of embedding said authentication data in said regeneration program.

9. A system for delivering contents; said system in response to a download request of the contents, comprising:
means for generating authentication data using a date when said request is accepted, wherein said authentication data includes a start date of use specifying the start date of use for the contents and an end date of use specifying an expiration date of the contents; and
means for sending said contents, a regeneration program for said contents, and said authentication data, wherein said regeneration program comprises functions of:
acquiring a current date from a system timer;
determining first whether the last date of use of said contents is prior to said current date;
determining secondly whether said current date is prior to said end date of use;
regenerating said contents if determinations made by both of said determining functions result in true; and
updating said last date of use with a date when the regeneration of said contents is finished.

10. The system according to claim 9, further comprising means for encoding at least a part of said contents using encryption data contained in said authentication data and forming encoded contents, wherein said regeneration program further comprising the function of decoding said encoded contents using said encryption data.

11. The system according to claim 10, wherein said regeneration program further comprising the function of nullifying said encryption data if a determination made by a determining function results in false.

12. The system according to claim 9, wherein said authentication data is recorded using means taken from a group of means including:
storing means for storing said authentication data in a file generated as a hidden file of a system in which said regeneration program is executed;
first embedding means for embedding said authentication data in said contents; and
second embedding means for embedding said authentication data in said regeneration program; and
any combination of these means.

13. A program executable by a computer to perform a method for utilizing contents; the program comprising the functions of:
acquiring authentication data including a start date of use specifying the start date of use for the contents, an end date of use specifying an expiration date of the contents, and a last date of use specifying when the contents were last used;
acquiring a current date from a system timer;
determining first whether said last date of use is prior to said current date;
determining secondly whether said current date is prior to said end date of use;
regenerating said contents if determinations made by both of said determination functions result in true; and updating said last date of use with a date when the regeneration of said contents is finished.

14. The program according to claim 13, wherein at least a part of said contents are encoded using encryption data contained in said authentication data, the program further comprising the functions of:
decoding the encoded contents using said encryption data; and
nullifying said encryption data if a determination made by either the first or second determining step results in false.

15. The method according to claim 1, wherein a program for implementing a counter function is provided in a computer system on which said contents are utilized, the counter operating while the system operates and/or an OS of said system operates, the method further comprising the steps of:
initializing a time of said counter function with a date acquired from the system timer when activating said system or said OS of said system;
recording a difference between a date of said counter and a date of the system timer when utilizing said contents; and
correcting said last date of use and said end date of use or said current date using a time period corresponding said difference.

16. The method according to claim 5, wherein the sending steps sends said contents, a regeneration or execution program for said contents and said authentication data or an encoded file thereof, and sends a program at the same time which implements a counter function that always operates while the system operates or an OS of said system operates, and wherein the program for implementing said counter comprises the function of initializing a time of said counter function with a date acquired from the system timer when activating said system or said OS of said system; and the function of counting a time independent of said system timer, and wherein said regeneration and execution program further comprises the function of recording a difference between a date of said counter and a date of the system timer; and the function of correcting said last date of use and said end date of use or said current date using a time period corresponding said difference.

17. The system according to claim 9, wherein the sending means sends said contents, a regeneration or execution program for said contents and said authentication data or an encoded file thereof, and sends a program at the same time which implements a counter function that operates while the system operates and/or an OS of said system operates, and wherein the program for implementing said counter comprises the function of initializing a time of said counter function with a date acquired from the system timer when activating said system or said OS of said system, and the function of counting a time independent of said system timer, and wherein said regeneration and execution program further comprises the function of recording a difference between a date of said counter and a date of the system timer; and the function of correcting said last date of use and said end date of use or said current date using a time period corresponding said difference.

18. The program according to claim 13, wherein the program includes a counter program comprising the functions of initializing a time of said counter function with a date acquired from the system timer when activating the system or said OS of said system; and counting a time independent of said system timer, the program further comprising the functions of:
acquiring a date from the counter program;
recording a difference between a date of said counter and a date of the system timer; and
correcting said last date of use and said end date of use or said current date using a time period corresponding said difference.

19. The method according to claim 1, wherein the step of regenerating includes executing the contents.

20. An article of manufacture comprising a computer usable medium having computer readable program code means embodied therein for causing content utilization, the computer readable program code means in said article of manufacture comprising computer readable program code means for causing a computer to effect the steps of claim 1.

21. An article of manufacture comprising a computer usable medium having computer readable program code means embodied therein for causing content delivery, the computer readable program code means in said article of manufacture comprising computer readable program code means for causing a computer to effect the steps of claim 5.

22. A program storage device readable by machine, tangibly embodying a program of instructions executable by the machine to perform method steps for content utilization, said method steps comprising the steps of claim 1.

23. A program storage device readable by machine, tangibly embodying a program of instructions executable by the machine to perform method steps for content delivery, said method steps comprising the steps of claim 5.

24. A computer program product comprising a computer usable medium having computer readable program code means embodied therein for causing content delivery, the computer readable program code means in said computer program product comprising computer readable program code means for causing a computer to effect the functions of claim 9.
